(19) United States
(12) Patent Application Publication
(10) Pub. No.: US 2006/0059284 A1
(43) Pub. Date: Mar. 16, 2006

(54) Data processing device

(75) Inventors: Makoto Saen, Koganei (JP); Kei Suzuki, Kokubunji (JP)

Correspondence Address: Stanley P. Fisher;Reed Smith LLP, Suite 1400, 3110 Fairview Park Drive, Falls Church, VA, 22042-4503, US

(73) Assignee: Renesas Technology Corp.

(21) Appl. No.: 11/202,280

(22) Filed: Aug. 12, 2005

(30) Foreign Application Priority Data
Sep. 10, 2004 (JP) 2004-263313

(51) Int. Cl. G06F 13/36

(52) U.S. Cl. 710/117

(57) ABSTRACT

A data processing device which, even if congestion occurs on a bus circuit of a specific processing circuit in an LSI in which multiple circuit modules are connected by buses, can fully actualize the performance potential of the system on chip. Buses and slave circuits on which accesses concentrate are provided with observation blocks. Each observation block has a mechanism to notify system control circuits such as a clock controller and master circuits such as CPU cores of the acquired status information, and each master circuit further has a mechanism capable of dynamically altering the priority order for notifying the bus circuits and slave circuits of the priority order of processing.

### CLAIM OF PRIORITY

The present application claims priority from Japanese application JP 2004-263313 filed on Sep. 10, 2004, the content of which is hereby incorporated by reference into this application.

### FIELD OF THE INVENTION

The present invention relates to a large-scale integrated circuit (LSI) having observation blocks for observing the status of the system, and more particularly to a data processing device provided with observation blocks to be formed over a semiconductor substrate. The LSI to which the invention relates here is an LSI chip containing arithmetic and processing circuits including a central processing unit (CPU) and a digital signal processor (DSP) and an interface with memory circuits including a synchronous DRAM (SDRAM).

### BACKGROUND OF THE INVENTION

Along with the increase in the integrating scale of LSIs, the main use of LSIs has shifted from CPUs alone to system-on-chips (SOCs), and the trend to require LSIs to have a high level of system performance is becoming increasingly dominant. Where many circuit modules are incorporated into a single LSI, performance bugs beyond the anticipation of programmers often arise. In a typical example of this problem, access requests from different circuits concentrate on a bus that connects circuit modules in the chip, making it impossible to secure a transfer band required by moving pictures and therefore to display the moving pictures smoothly.

If the bus width or the parallelism of arithmetic processors is increased to be sufficient for the highest expected level of performance requirement, such a physical abundance policy would boost the cost and accordingly invite an economic failure.

However, even in such congestion of processing requests, they may include some whose real time requirement is not no strict and which therefore need no hurried processing, and most such problems can be solved by optimizing the processing formula instead of relying on physical abundance.

Earlier attempts to solve this problem include a method by which the sequence of processing on the bus is optimized by designating in a priority setting register of the bus circuit a priority order regarding the competitive acquisition of the bus access right among circuits connected to the bus, and another by which a priority regarding the bus access right is determined on the basis of comparison with a preset quantity of transfers on the bus.

As examples of the related art regarding such processing on the bus, JP-A No. 265446/1997 and JP-A No. 063615/1998 can be cited.

In JP-A No. 265446/1997, which relates to a bus control device, it is stated that the use of a control bus is facilitated by setting in each program group the priority order of rights to use the control bus for the groups of programs.

JP-A No. 063615/1998 describes, regarding a method and system for observing bus performance, the measurement of the state of use of buses outside the chip.

However, where many circuit modules are integrated over an LSI, there often arises congestion of processing requirements not only on a bus circuit but also on an external interface (I/F) control circuit, such as a universal serial bus (USB), and on a specific-purpose arithmetic processor, resulting in an increased need for optimizing the state of the whole system by feedback.

Thus in an LSI in which multiple circuits are connected to a bus circuit, there is a problem that the congestion of the bus circuit or some specific processing circuit prevents the potential performance capability of the whole LSI from being fully utilized.

Incidentally, neither JP-A No. 265446/1997 nor JP-A No. 063615/1998 makes any mention of the measurement of the state of use of buses within the chip and a mechanism of feedback based on the result of that measurement.

In the rest of this specification, circuits which for themselves issue access requests to other circuits, such as a CPU, and circuits for processing image information, such as an MPEG decoder and a graphics processing circuit, will be referred to as master circuits, and circuits which, conversely, receive and process access requests from other circuits, such as a memory interface, will be referred to as slave circuits.

An object of the present invention, therefore, is to provide a data processing device permitting optimization by feeding back the state of the whole system.

### SUMMARY OF THE INVENTION

Typical aspects of the invention disclosed in this specification are described. One of the data processing devices disclosed in the specification includes a bus to which multiple circuits are connected, a bus circuit for controlling data transfers on the bus, and a clock control circuit for determining the operating frequency of the bus and supplying the bus with clock signals, the elements being formed over a single semiconductor substrate, wherein the bus circuit has a first observation block for observing data transfers on the bus, the first observation block notifies the clock control circuit of first information indicating the state of data transfers on the bus, and the clock control circuit alters the frequency of the clock signals by using the first information.

Another of the data processing devices disclosed in the specification has first and second bus masters, wherein the first bus master has a first conversion circuit for converting a logical address into a physical address, the second bus master has a second conversion circuit for converting a logical address into a physical address, each of the first and second conversion circuits has a priority setting bit, and the priority setting bit is rewritable by a program, the data processing device selecting one of a bus access by the first bus master and a bus access by the second bus master on the basis of a priority order set in the priority setting bit.

The invention enables data processing devices to be improved in performance.

### BRIEF DESCRIPTION OF THE DRAWINGS

FIG. 1 shows the configuration of an LSI equipped with observation blocks according to the present invention;

FIG. 2 illustrates a program into which a re-sequencing designator indicating one example of program utilizing observation blocks according to the invention is embedded;

FIG. 3 illustrates a program resulting from the expansion of the program shown in FIG. 2 by a code expansion program;

FIG. 4 shows an example of configuration of a status referencing circuit MSTAT;

FIG. 5 illustrates the configuration of feedback of the bus status to the division ratio;

FIG. 6 shows an example of TLB with a processing priority bit;

FIG. 7 shows an example of system utilizing a TLB with a processing priority bit;

FIG. 8 is a signal waveform diagram of a case in which the division ratio setting is not dynamically altered, showing transfers on a system bus SBS in FIG. 5;

FIG. 9 is a signal waveform diagram of a case in which the division ratio setting is dynamically altered, showing transfers on the system bus SBS in FIG. 5;

FIG. 10 is a circuit diagram of a bus observation block ESBS;

FIG. 11 is a circuit diagram of an observation block EDMIF of a DRAM control circuit;

FIG. 12 shows an example of configuration for performance optimization using a system according to the invention, which simultaneously measures and outputs the statuses of constituent circuits at regular intervals of time;

FIG. 13 illustrates the distribution over time of the number of memory access requests from circuits where an arbiter having no mechanism to permit adjustment of the ratio of memory resources by register setting is used; and

FIG. 14 illustrates the distribution over time of the number of memory access requests from circuits where an arbiter having a mechanism to permit adjustment of the ratio of memory resources by register setting is used.

### DETAILED DESCRIPTION OF THE PREFERRED EMBODIMENTS

According to the invention, the following two mechanisms are added. One is an observation block which, provided for each of bus circuits and slave circuits on which processing requests concentrate, feeds back this state to system control circuits including master circuits and a clock control circuit. The other is a mechanism which, disposed within each master circuit, is capable of dynamically changing over the priority order of processed contents and notifying the bus circuits and slave circuits of the resultant information. These mechanisms will be described in detail with reference to the accompanying drawings.

### First Embodiment

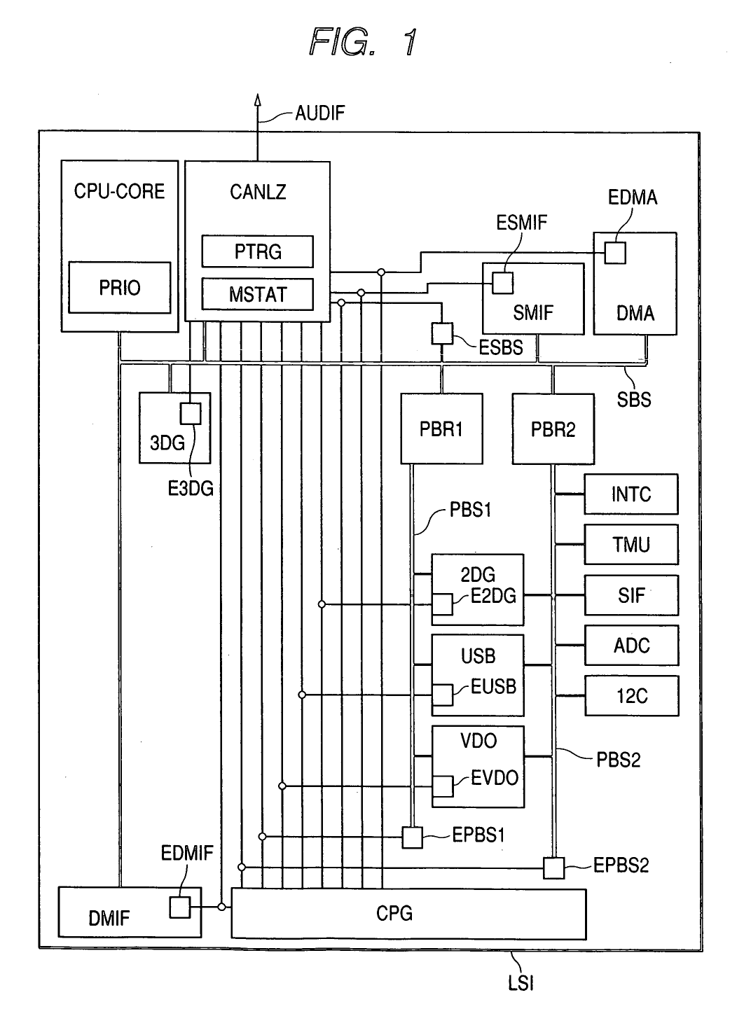

FIG. 1 shows the configuration of a data processing device equipped with an observation block according to the invention. The data processing device according to the invention is, though not limited to, an LSI formed over a single semiconductor substrate. As shown in FIG. 1, this LSI includes a CPU core (CPU-CORE), a system bus SBS, a bus bridge PBR1 for performing protocol exchanges between this system bus SBS and a peripheral bus PBS1, a bus bridge PBR2 for performing protocol exchanges between the system bus SBS and a peripheral bus PBS2, a direct memory access controller DMA for transferring data on the system bus without passing the CPU core, a DRAM interface controller DMIF, an SRAM/ROM interface controller SMIF, a 3D graphics accelerator 3DG, a 2D graphics accelerator 2DG, a USB interface controller USB, a video interface controller VDO, a clock controller CPG, an interrupt controller INTC and other peripheral circuits.

Besides these circuits, every one of the circuits on which processing requests from master circuits concentrate (the bus circuits and slave circuits) is equipped with a status observation block. Reference sign ESBS denotes an observation block for the system bus; EPBS1 denotes an observation block for the peripheral bus PBS1; EPBS2 denotes an observation block for the peripheral bus PBS2; ESMIF denotes an observation block for the SRAM/ROM interface controller SMIF; EDMIF denotes the observation block for the DRAM interface controller DMIF; EDMA denotes the observation block for DMA; E3DG denotes the observation block for the 3D graphics accelerator 3DG; E2DG denotes the observation block for the 2D graphics accelerator 2DG; EUSB denotes the observation block for the USB interface controller USB; and EVDO denotes the observation block for the video interface controller VDO.

A central analyzer CANLZ is a circuit for putting in order the items of information obtained from these observation blocks. CANLZ includes a circuit MSTAT for enabling the CPU core or the like to reference the status of each monitored circuit made known by the observation block and a PTRG circuit for issuing triggers in a designated cyclic period. Incidentally in this specification, the group of signal lines linking each observation block and the central analyzer CANLZ shall be referred to as ANET.

<Details of Status Measuring Unit>

A status measuring unit will be described hereupon. There are a number of types of observation block according to the tyne of circuit to be observed. Typical examples include a type for observing the status of buses and another, a type for observing the status of slave circuits. They will be described below one after the other.

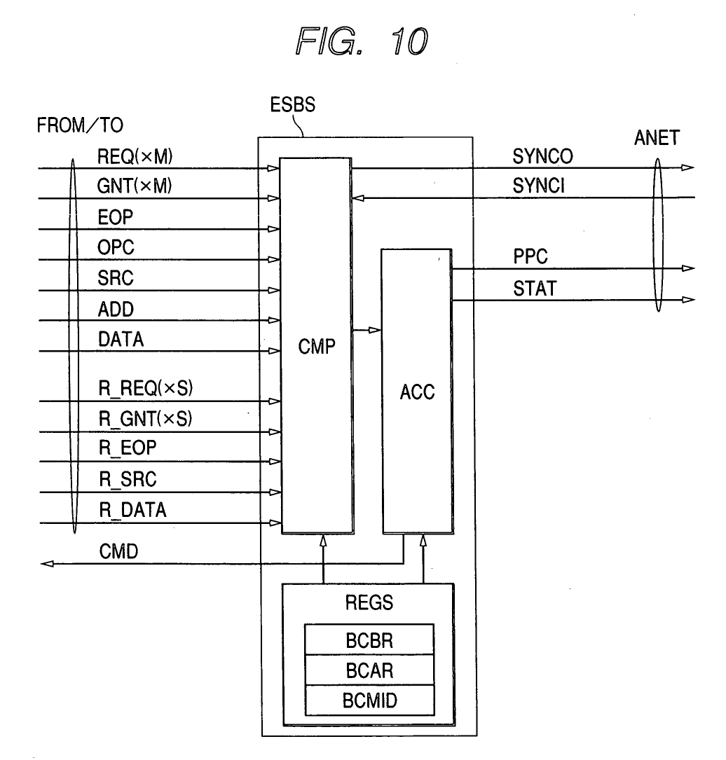

FIG. 10 is a circuit diagram of a bus observation block ESBS. ESBS observes and measures the status of the system bus SBS, and notifies other circuits of the results of observation and measurement. The system bus in this embodiment has a split structure including a request bus for conveying requests from the bus master to bus slaves and a response bus for conveying responses to the requests, each independent of the other, and the bus observation block ESBS for each observes both buses.

For the purpose of observing the request bus, each mechanism has, as inputs from the system bus, a request bus request REQ, an end of packet EOP indicating the boundary of a request, a request bus grant GNT (acknowledge) indicating the grant of a request bus request, a request bus command OPC, SRC which is an ID for identifying the master circuit having issued the request bus request, a request bus address ADD, and write data DATA. For the purpose of observing the response bus, each mechanism has, as inputs from the system bus, a response bus request R_REQ, an end of packet R_EOP indicating the boundary of the response bus request, a response bus grant GNT (acknowledge) indicating the grant of the response bus request, R_SRC which is an ID for identifying the master circuit having issued the request, and read data R_DATA. Incidentally, parenthesized xM and xS indicate the numbers of bus masters and bus slaves, respectively.

Other signals include SYNCI and SYNCO for performing synchronized operations with other circuits, and PPC and STAT for transmitting status observation information on SBS. PPC indicates the state of bus use in a pre-designated period among other things, while STAT indicates the current state of bus use. Out of these signals, SYNCO, SYNCI, PPC and STAT are signals contained in ANET of FIG. 10. The observation block ESBS is connected to another observation one or the central analyzer CANLZ via ANET.

Next will be described the internal configuration of the bus observation block ESBS. ESBS includes a control register circuit REGS for designating the conditions of observation, a circuit CMP for comparing the conditions of observation designated by the control register REGS with the value of an observation signal inputted from the system bus SBS and detecting satisfaction of the conditions, and a circuit ACC responsive to the reception of the comparison from CMP for performing the processing designated by the control register REGS. CMP can transmit the detected timing to another circuit (observation block or the central analyzer) via SYNCO or, conversely, receive a timing detected by another circuit (observation block or CANLZ) via SYNCI to enable multiple observation blocks to operate simultaneously or sequentially

The operation of ACC is to generate status observation information and transmit information by way of a PPC signal or STAT. BCBR is a register for designating the conditions of observation, which include the items of status observation to be stated below, the size and type of the bus command and whether or not to have synchronism measurement by SYNCI performed. BCAR designates the address of each bus transaction which is an object of a register incidental to BCBR. BCMID also designates the master circuit requesting each bus transaction which is an object of a register incidental to BCBR and the slave circuit to which the request is addressed.

In order to improve the performance of the data processing device the status observation information hereby generated is used. The items of status observation of ESBS and the method of generating each will be described below.

<Counting of the Number of Times of Request Bus Request Acceptances>

The number of times all of REQ, EOP and GNT are 1 (active), namely the number of times a request bus request has been permitted (accepted), is counted, and conveyed by way of a PPC signal. It is possible then to designate a specific bus master circuit by designating it in a register BCMID within the control register circuit REGS. Similarly, it is also possible to designate a bus request destination address by adding the ADD signal to the conditions to be compared.

<Counting of the Number of Request Bus Request Waiting Cycles>

The number of bus cycles in which the request bus request REQ is 1 (active) and the request bus grant GNT is 0, namely the number of bus cycles from the time a request bus request REQ is issued until it is permitted (accepted), is counted, and conveyed by way of a PPC signal. It is also possible then to designate a specific bus master circuit by designating it in the register BCMID within the control register circuit REGS. Similarly, it is also possible to designate a bus request destination address by adding the request bus address ADD signal to the conditions to be compared.

<Counting of the Number of Response Bus Request Acceptances>

The number of times all of the response bus request R_REQ, the end of packet R_EOP and the response bus grant R_GNT are 1 (active), namely the response bus request has been issued and permitted is counted, and conveyed by way of a PPC signal. It is also possible then to designate a specific bus slave circuit by designating it in the register BCMID within the control register circuit REGS.

<Counting of the Number of Response Bus Request Waiting Cycles>

The number of bus cycles in which the R_REQ is 1 (active) and R_GNT is 0, namely the number of bus cycles from the time the response bus request R_REQ has been issued and until it is permitted (accepted), is counted, and conveyed by way of a PPC signal. It is also possible then to designate a specific bus slave circuit by designating it in the register BCMID within REGS.

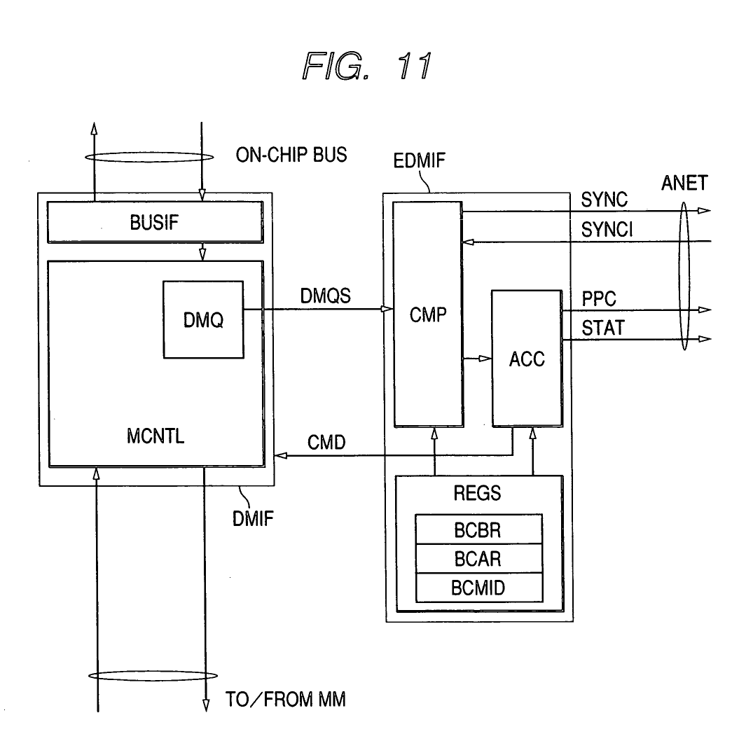

Next, a circuit diagram of the observation block EDMIF of the DRAM interface controller DMIF is shown in FIG. 11 as a slave status observing type. DMIF has an on-chip bus interface BUSIF and MCNTL for memory control, and, within MCNTL, a queue DMQ in which requests accepted from master circuits are accumulated. EDMIF has as its input DMQS for observing the state of DMQ. This DMQS includes the number of requests accumulated in DMQ and the types of commands executed (including read/write and size) and as other signals has SYNCI and SYNCO for synchronized operations with other observation blocks, and PPC and STAT for transmitting status observation information on DMIF. Its internal configuration is the same as that of the bus observation block ESBS.

In order to improve the performance of the data processing device, the status observation information generated here is used. The items of status observation information of EDMIF and the method of generating each will be described below.

<Number of DMIF Commands Executed>

The sum of the executed commands notified by DMQS is counted, and conveyed by way of a PPC signal. It is also possible to specify the sum by the type of command (read/write) and the size of command.

<State of Use of DMIF>

The number of requests acquired by DMQS and accumulated in DMQ is transmitted as available processing capacitv information _n the DRAM interface controller DMIF by way of a STAT signal. When DMIF is not in use, the value of the STAT signal is 0.

Next will be described a number of embodiments intended for performance optimization of observation blocks.

### Second Embodiment

This embodiment has a status referencing circuit MSTAT to enable the state of each observation object circuit obtained from the observation blocks to be referenced from the CPU core as shown in FIG. 1.

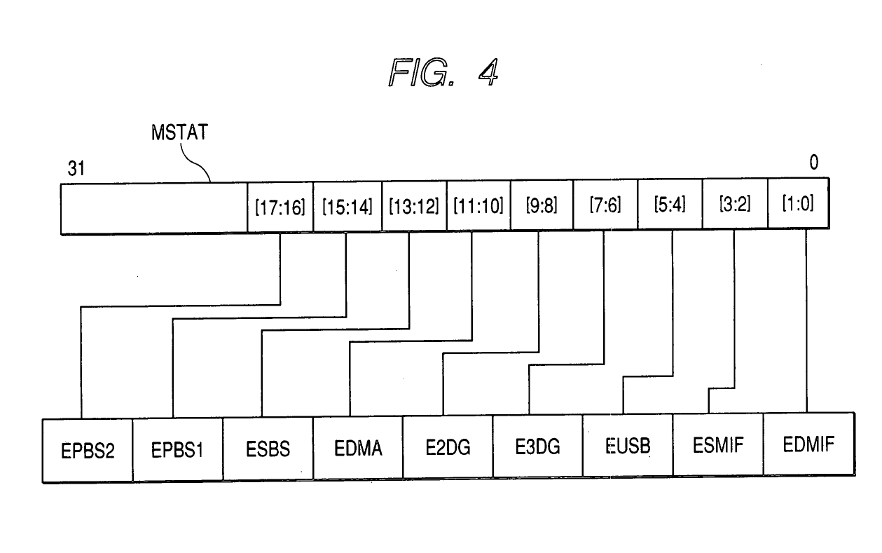

FIG. 4 shows an example of MSTAT. MSTAT is packaged as a 32-bit register, and each bit of the register show whether or not the pertinent module is usable. Information on whether or not each package is in a usable state is conveyed by way of a STAT signal connected from each of the status observation blocks ESBS, EPBS1, EPBS2, ESMIF, EDMIF, EUSB, E3DG, E2DG and EDMA in FIG. 1 to MSTAT. For instance, bits 0 and 1 for the status referencing circuit MSTAT indicate whether or not the DRAM interface controller DMIF is usable. In other words, it indicates the state of the command queue DMQ which DMIF has. If this value is 0, an entirely unoccupied state is indicated, or if it is 1 or above, it means that processing is already booked for, and the issuance of any more processing request would be subject to waiting for some duration.

Further the status referencing circuit MSTAT which is shown to be packaged within the central analyzer CANLZ of the system bus SBS in FIG. 1 may as well be packaged in, for instance, the CPU core. If it is packaged in the CPU core, there will be an advantage of minimizing the access latency from the CPU core to MSTAT, but the access latency from any other circuit will become relatively great. It may as well be packaged in multiple circuits.

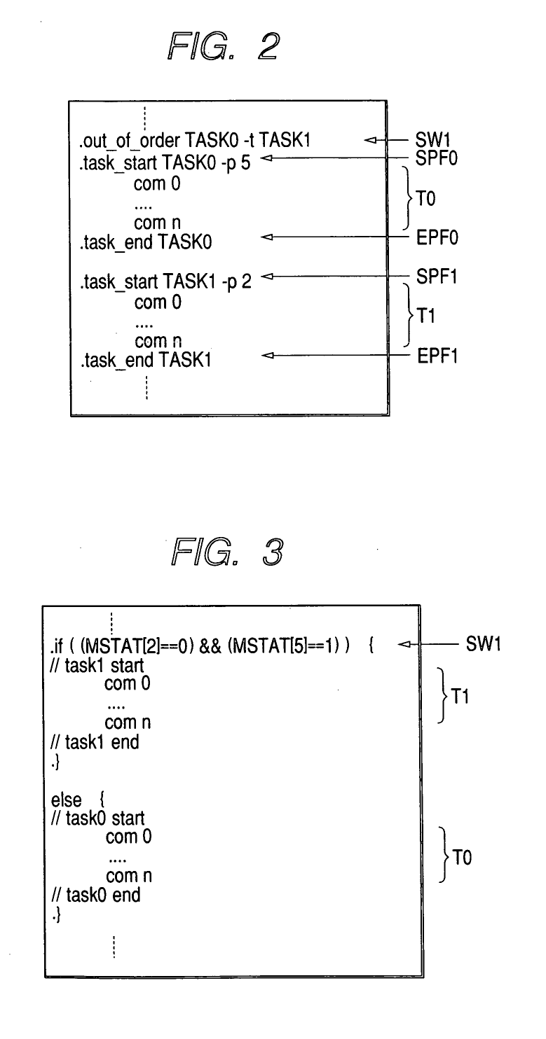

Next will be described a method of performance improvement utilizing the status referencing circuit MSTAT. Specifically, the method described below is one using a code expansion program as one form taking into account the transplanting ease of programs. A programmer describes in advance processing whose sequence can be altered in a re-sequencing designator recognizable by the code expansion program. FIG. 2 and FIG. 3 show one example, in which two tasks TASK0 and TASK1 are described. FIG. 2 shows an example of program into which a re-sequencing designator is embedded and FIG. 3 shows a program resulting from its development by the code expansion program.

In FIG. 2, SW1, SPF0, EPF0, SPF1 and EPF1 are re-sequencing instructions. The T0 and T1 parts are the real program parts of task 0 and task 1, respectively. SW1 indicates that TASK0 and TASK1 can be re-sequenced. SPF0 indicates the start of task 0 and that task 0 uses a resource corresponding to No. 5 of MSTAT. In FIG. 4, it is shown that the resource of task 0 corresponding to No. 5 of MSTAT uses USB. EPF0 indicates the end of task 0. Similarly; SPF1 indicates the start of task 1 and that task 1 uses a resource corresponding to No. 2 of MSTAT. Therefore it is shown that task 1 uses SMFI in FIG. 4. EPFO indicates the end of task 1. These designators allows expansion of the executing sequence of task 0 and task 1 into a dynamically controllable form as judged from the operating states of the resource corresponding to No. 5 and of that corresponding to No. 2.

In FIG. 3 which shows an example of result of expansion, SW1 is a conditional expression for designating the executing sequence of task 0 and task 1. Since bit 1 is put on for the register of No. 5 of MSTAT in SW1, the resource corresponding to No. 5 to be used by task 0 is not in a usable state. On the other hand, as bit 0 is put on for the register of No. 2 of MSTAT to be used by task 1, the corresponding resource is in a usable state. It is thereby indicated that task 1 is executed ahead of task 0. As in FIG. 2, the T0 and T1 parts are the real program parts of task 0 and task 1, respectively.

### Third Embodiment

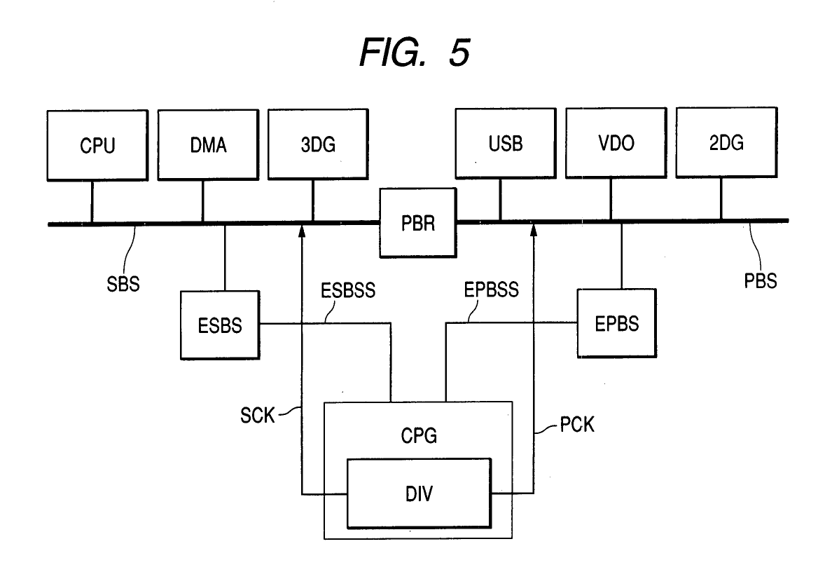

FIG. 5 shows a mechanism for feeding back information from an observation block for system bus ESBS on the system bus SBS and a bus observation block EPBS on the peripheral bus PBS to the clock controller CPG. ESBSS and EPBSS are information conveying signals from the respective observation blocks. The clock controller CPG is equipped inside with a frequency divider DIV which divides the frequency of the reference clock, and supplies its clocks to individual circuits. In this embodiment, it supplies a clock SCK to the system bus SBS and a clock PCK to the peripheral bus PBS. The clock controller CPG knows bus statuses from the ESBSS and EPBSS signals, dynamically alters the division ratio setting to match the states, and accordingly alters the clocks to be supplied to these bus circuits. These localized frequency alterations can raise the operating frequency in only the needed part, and thereby allows optimization in both power and processing speed aspects. Moreover, as the frequency alteration is achieved by changing over the division ratio, the change-over can be accomplished in cycle units.

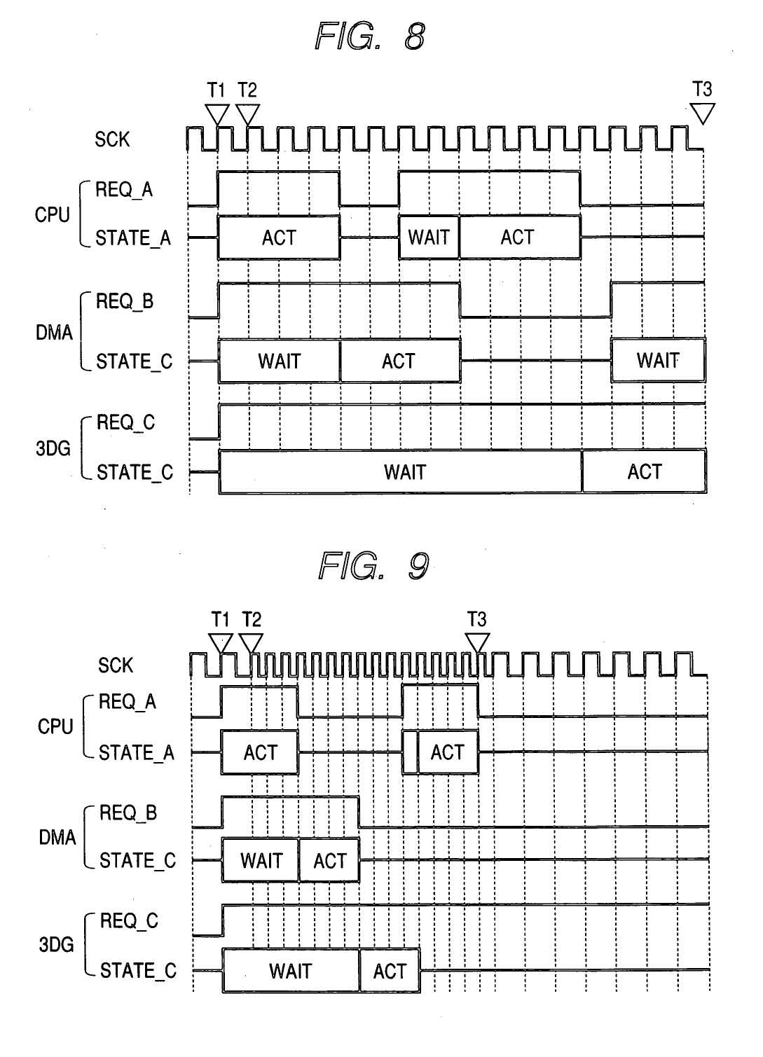

FIG. 8 and FIG. 9 illustrate transfers on the system bus SBS shown in FIG. 5. FIG. 8 is a signal waveform diagram of a case in which the above-described mechanisms are not used and FIG. 9 is a signal waveform diagram of a case in which the mechanisms are used. Each ACT in the waveform indicates a period during which valid processing is actually performed and each WAIT, a waiting period due to bus congestion. At a point of time T1, bus access requests from CPU, 3DG and DMA occur at the same time. Then, at the point of time T1 in FIG. 9, the bus observation block ESBS detects the occurrence of the multiple bus access requests, which is made known to the clock controller CPG via ESBSS. In response to this, CPG alters the division ratio, and doubles the clock frequency SCK of the object bus circuit from a point of time T2 on. Conversely, at a point of time T3, ESBS detects the absence of access congestion on the bus, which is made known to the clock controller CPG via ESBSS. In response to this, CPG alters the division ratio, and returns the clock frequency SCK of the object bus circuit to the frequency at the point of time T1. The transfer bandwidth can be doubled only during the period from T2 till T3 in which there is processing congestion. As a result, to compare the case illustrated in FIG. 9 with that in FIG. 8 in which there is no mechanism to feed back information from the bus observation block EPBS to the clock controller CPG described in the context of this embodiment for a similar transfer, the transfer bandwidth can be doubled during the period from T2 till T3 to approximately halve the length of time taken by the transfer. Furthermore, since the frequency of no other part is altered, the increase in power consumption due to the frequency raise can be minimized. The power saving effect of this embodiment can be in many cases 3% to 5% approximately in view of the circumstances that clock power in an LSI accounts for 30% to 50% of the total power consumption by the LSI and that the activation rate of the on-chip bus part is high.

As hitherto described, the mechanism to feed back information from multiple processing-congested circuits including bus circuits and designate the sequence of processing makes it possible to reduce the time of waiting for processing and to improve the performance of the data processing device using an LSI.

### Fourth Embodiment

Now will be described a mechanism which measures the state of each circuit in the LSI at regular intervals of time and outputs the result of measurement. This mechanism is effective for easing in a short period of time deterioration in system deterioration invited by resource competition in a certain circuit. Along with an increase in the scale of LSIs and the resultant integration of many functions in a single chip, multiple processing functions are simultaneously executed on an LSI, and hardly predictable performance deterioration occurs. Resource competition may arise on buses, memories or shared arithmetic processors.

However, against most cases of such resource competition, performance improvement can be achieved by (1) optimizing the ratio of resource distribution among the competitive processing requirements and (2) optimizing the start timing of each competitive processing. For efficient optimization of (1) or (2), it is necessary to specify the timing of competition and the processing involved. This embodiment is a mechanism to provide the relevant information.

In FIG. 1, PTRG denotes a trigger generation circuit which generates triggers in designated cyclic periods. The periodic pulses are supplied to each observation block by way of a SYNCI signal contained in ANET. Each observation block sends, matching that timing, the measured state to the central analyzer CLNLZ by way of a PPC signal. An external tool acquires these items of information via a dedicated interface AUDIF.

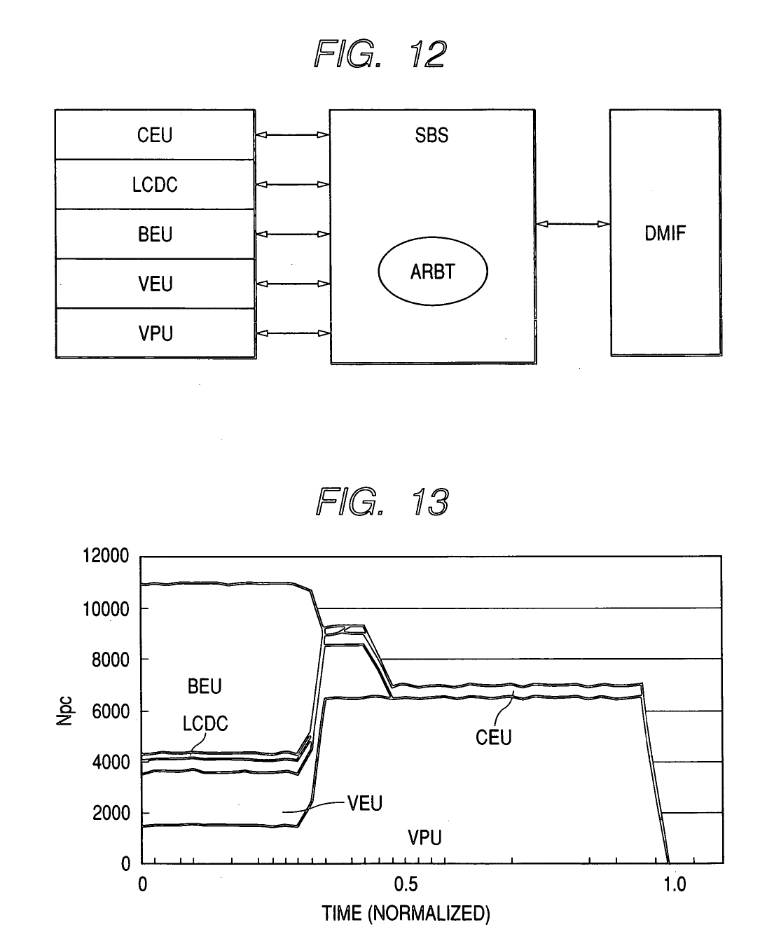

FIG. 12 shows an example of configuration for performance optimization using this system. In this case, processing of an input image from a camera, processing to display it on an LCD, processing to synthesize multiple images, processing of format conversion and processing of image compression by MPEG take place at the same time, and memory accesses for them compete with one another. The system performance can be improved by optimizing the ratio of memory resource distribution among these competitive processing functions. These processing functions are performed by different circuits: processing of an input image from a camera by a circuit CEU; processing to display it on an LCD by a circuit LCDC; processing to synthesize images by a circuit BEU; processing of format conversion by a circuit VEU; and processing of image compression by a circuit VPU. These circuits are connected to a memory controller DMIF via the bus SBS, and the ratio of distribution of memory resources is determined by an arbiter ARBT in the bus SBS.

The bus arbiter ARBT in this embodiment is equipped with a mechanism capable of adjusting this ratio by register setting.

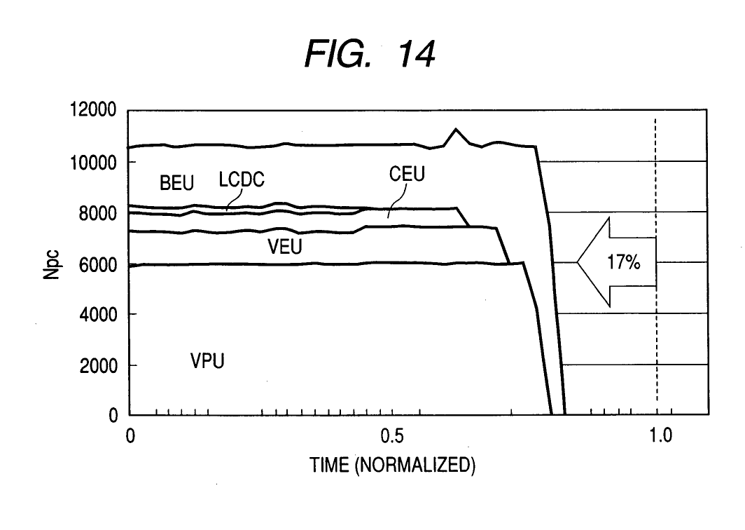

FIG. 14 is a graphic expression of the results obtained by this embodiment, wherein the distribution over time of the number of memory access requests from each circuit is shown. The axis of abscissa represents the normalized time and the axis of ordinate, the number of times of executions Npc for each processing function. The shorter the time taken to complete all these processing functions is, the superior the performance is. The numbers of memory access request issued by CEU, LCDC, BEU, VEU and VPU to the memory are counted by observation blocks respectively connected to them, and the results are outputted in designated cyclic periods, matched with the timing of the trigger generating period of PTRG. The results acquired via AUDIF are graphically expressed here.

The data to be handled need not be the number of memory access requests, but may be the number of waiting cycles or the like. The use of the arbiter equipped with a mechanism capable of adjusting the ratio among memory resources in this embodiment by register setting makes it possible to identify the proportion of the memory resource used by each processing function, and to efficiently adjust ARBT mentioned above. As a result, the length of processing time can be reduced by as much as 17% in the case illustrated in FIG. 14 compared with the case of FIG. 13 where an arbiter having no mechanism of adjusting by register setting is used.

### Fifth Embodiment

Now will be described the configuration for controlling the priority order of processing on the bus master side.

As described above, a key to system performance improvement is how to efficiently utilize condition resources among multiple masters. Competition over memory availability is one example. Media processing such as image displaying or compression requires large-volume processing on a real time basis, and uses most of the bandwidths of buses and memories. In processing related to the compression of moving pictures of the video graphic array (VGA; 640×480 dots) class, memory accessing of 300 MB/s to 400 MB/s may occur. In such a case, other functional modules need to share the use of the remaining bandwidth. Processing by the CPU should be or need not be given priority depending on what is to be processed, and the necessary bandwidth may differ from one processing function to another. A typical case of processing that deserves priority is a communication-related interrupt. In this case, if a long delay occurs in processing, some of the data may be missed. On the other hand, a low level of priority would pose no problem to periodic polling of the like.

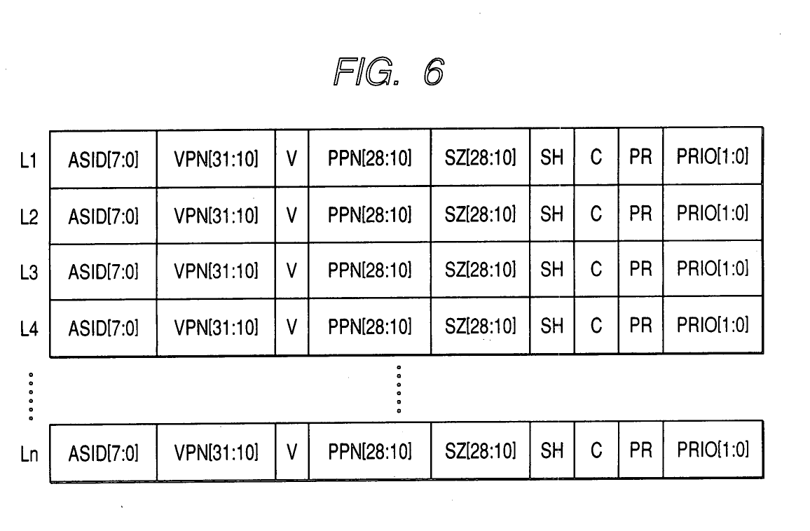

As a feature of configuration to control the priority of processing, a priority setting bit is added into a translation look-aside buffer (TLB) circuit for conversion from a logical address into a physical address within the CPU core. FIG. 6 shows one example. Each line (L1, L2, L3, L4, . . . , Ln) matches one page entry or another. VPN represents a virtual page address; PPN represents a physical page address; and PRIO represents a priority setting bit. Other bits include a virtual page process identifier denoted by ASID, the valid bit of each entry denoted by V, a page size bit denoted by SZ, the protection level of each entry denoted by PR, a bit that indicates page sharing by multiple processes denoted by SH, and a caching valid bit denoted by C. As it is possible to set priority for each entry of TLB, the priority order is enabled to be dynamically controlled in the unit of processing which the programmer is conscious of.

Next will be shown an example of its operation.

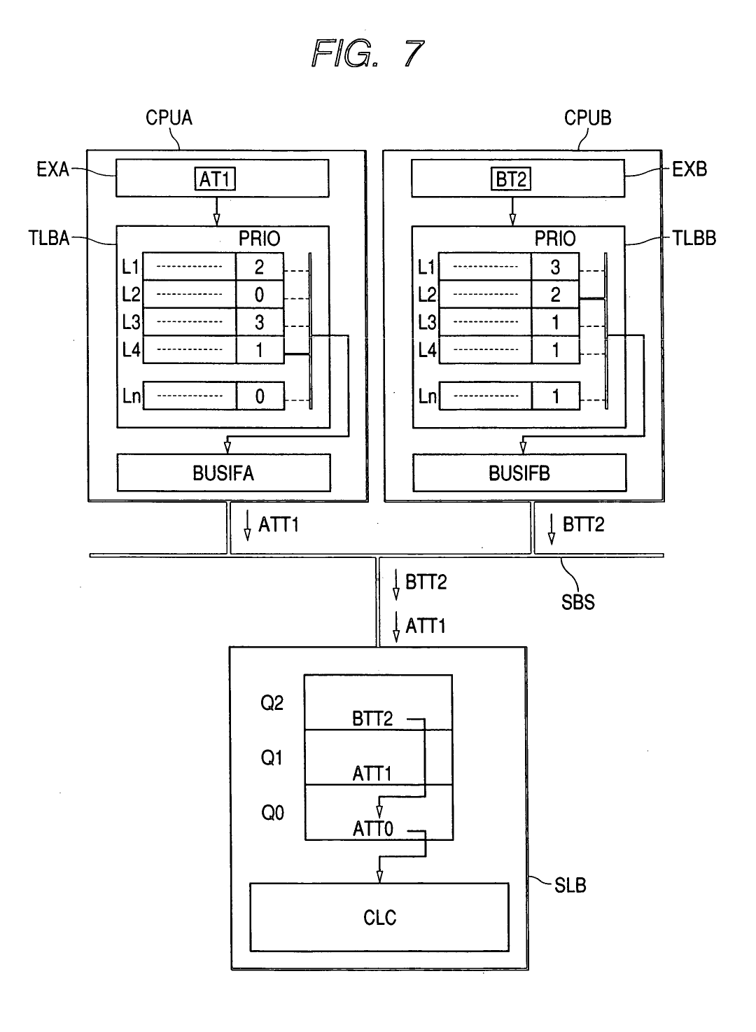

FIG. 7 shows a system having multiple CPU cores (CPUA and CPUB here), which share a certain slave circuit SLB. Each of CPUA and CPUB has within it TLB (TLBA or TLBB) containing the priority setting bit PRIO. It is supposed that, at a certain point of time T1, CPUA is executing processing AT1 and along with this an entry 4 in TLBA is used. At this time, CPUA issues a request ATT1 accompanied by information on priority 1 incidental to the entry 4 to the slave circuit SLB via the system bus SBS. It is supposed that a priority followed by a larger numeral is higher in the order of priority. It is further supposed that, at the immediately following point of time T2, CPUB is executing processing BT2 and along with this an entry 1 in TLB is used. At this time, CPUB issues a request BTT2 accompanied by information on priority 3 incidental to the entry 1 to the slave circuit SLB via the system bus SBS.

On the other hand, the slave circuit SLB has processing queues Q0, Q1 and Q2 for holding accepted requests and a processing unit CLC. The sequence of processing by the processing unit CLC is the processing queues Q0, Q1 and Q2. First, the processing unit CLC accepts a request from CPUA mentioned above and an access request from CPUB in this order, and stores them in a processing queue inside in the order of ATT1 and BTT2. Then the slave circuit SLB re-sequences the priority order in the processing queues so as to execute BTT2 ahead of ATT1 on the basis of the priority order PRIO within the processing queues.

To add, when the priority order is to be controlled among multiple CPU cores as described above, both CPU cores need not have a mechanism to dynamically alter the priority order. For instance, it is conceivable to place one of them at a fixed intermediate level of priority. Also, the priority order control mechanism need not belong to the CPU core or cores alone. The foregoing applies to a case in which another master circuit, such as another graphics accelerator, is equipped with such a mechanism.

Although the present invention has been described with reference to preferred embodiments thereof, the invention is not limited to these embodiments, but obviously it can be modified in design in various ways within the scope of not deviating from the spirit of the invention.

What is claimed is:

1. A data processing device comprising a bus to which a plurality of circuits are connected, a bus circuit for controlling data transfers on said bus, and a clock control circuit for determining the operating frequency of said bus and supplying said bus with clock signals, the elements being formed over a single semiconductor substrate, wherein:
said bus circuit has a first observation block for observing data transfers on said bus,
said first observation block notifies said clock control circuit of first information indicating the state of data transfers on said bus, and
said clock control circuit alters the frequency of said clock signals by using said first information.

2. The data processing device according to in claim 1, wherein:
said data processing device further has a bus master connected to said bus and a first bus slave,
said bus has, each independent of the other, a request bus for conveying a first request to have data transferred from said bus master to said first bus slave and a response bus for transmitting a response to said first request,
said bus master issues to said first bus slave via said request bus first requests for requesting data transfers, and
said first bus slave, receiving each of said first requests, issues via said request bus a second request for requesting the transfer of data matching said first request to said bus master.

3. The data processing device according to claim 2, wherein:
said first observation block counts the number of said first requests accepted, the number of bus cycles from the time each of said first requests was issued until said first request is accepted, the number of said second requests accepted, and the number of bus cycles from the time each of said second requests was issued until said second request is accepted, and outputs said first information on the basis of the results of said counting.

4. The data processing device according to claim 2, said data processing device is further provided with a second bus slave accessed by said bus master, a second bus to which said second bus slave is connected, and a bus bridge connected between said first bus and said second bus.

5. The data processing device according to claim 4, wherein:
said first bus slave has a second observation mechanism for observing the operating status of said first bus slave, and
said second bus slave has a third observation block for observing the operating status of said second bus slave,
said data processing device further having a status referencing circuit for holding information observed by said second and third observation blocks, wherein:
said bus master, when a first task and a second task are to be executed on a time division basis, determines the order of executing said first task and said second task on the basis of the information held by said status referencing circuit.

6. The data processing device according to claim 1, wherein:
said first observation block outputs said first information in prescribed cyclic periods.

7. The data processing device according to claim 4, wherein:
said data processing device has outside said data processing device an interface for outputting information, and
said first through third observation blocks output the results of observation to said interface in prescribed cyclic periods.

8. A data processing device having first and second bus masters, wherein:
said first bus master has a first conversion circuit for converting a logical address into a physical address,
said second bus master has a second conversion circuit for converting a logical address into a physical address,
each of said first and second conversion circuits has a priority setting bit, and
said priority setting bit is rewritable by a program,
said data processing device selecting one of a bus access by said first bus master and a bus access by said second bus master on the basis of a priority order set in said priority setting bit.

9. The data processing device according to claim 8, wherein:
each of said first and second conversion circuits has a plurality of entries and each of said plurality of entries has said priority setting bit.
